(19) United States
(12) Patent Application Publication
(10) Pub. No.: US 2026/0019992 A1
(43) Pub. Date: Jan. 15, 2026

(54) APPARATUS AND METHOD FOR ON-DEMAND SYSTEM INFORMATION COMMUNICATION

(71) Applicant: Lenovo (Singapore) Pte. Ltd., Singapore (SG)

(72) Inventor: Hyejung Jung, Northbrook, IL (US)

(21) Appl. No.: 18/772,629

(22) Filed: Jul. 15, 2024

(51) Int. Cl. H04W 68/02; H04W 72/231; H04W 74/0833

(52) U.S. Cl. CPC H04W 68/02; H04W 72/231; H04W 74/0833

(57) ABSTRACT

Various aspects of the present disclosure relate to methods, apparatuses, and devices for wireless communication. A user equipment (UE) may receive an indication that a first transmission of on-demand essential system information (SI) is triggered in a cell, wherein the transmission of on-demand essential system comprises on-demand essential SI comprising first essential SI. The UE may also receive the on-demand essential SI during a transmission window associated with the first transmission of on-demand essential SI. The UE may monitor for paging downlink control information (DCI) associated with the cell according to a first paging configuration. The UE may also monitor for paging DCI associated with the cell according to a second paging configuration and after a threshold duration elapses following the transmission window.

### TECHNICAL FIELD

The present disclosure relates to wireless communications, and more specifically to on-demand system information (SI) communication in a wireless communications system.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

Various aspects of the present disclosure relate to wireless communications, including improved methods and apparatuses for communicating (e.g., transmitting, receiving) on-demand SI in a wireless communications system. A UE may receive an indication that a first transmission of on-demand essential SI is triggered in a cell. Additionally, the UE may acquire (e.g., obtain, receive) on-demand essential SI of the cell during a transmission window associated with the first transmission of the on-demand essential SI. The UE may monitor for paging downlink control information (DCI) in the cell according to a first paging configuration. Additionally, the UE may monitor for the paging DCI in the cell according to a second paging configuration and after a threshold duration from an ending of the transmission window. For example, the UE may monitor for the paging DCI in the cell after a duration elapses (e.g., a timer expiration).

### BRIEF DESCRIPTION OF THE DRAWINGS

FIG. 1 illustrates an example of a wireless communications system in accordance with aspects of the present disclosure.

FIG. 2 illustrates an example of a process flow diagram that supports energy saving associated with communication of on-demand SI in accordance with aspects of the present disclosure.

FIG. 3 illustrates an example of a UE in accordance with aspects of the present disclosure.

FIG. 4 illustrates an example of a processor in accordance with aspects of the present disclosure.

FIG. 5 illustrates an example of a network entity (NE) in accordance with aspects of the present disclosure.

FIG. 6 illustrates a flowchart of a method performed by a UE in accordance with aspects of the present disclosure.

FIG. 7 illustrates a flowchart of a method performed by a NE in accordance with aspects of the present disclosure.

### DETAILED DESCRIPTION

Some wireless communication systems, including one or more UEs, base stations, network entities, or other communication equipment may support providing (e.g., transmitting, receiving) on-demand SI (also referred to as on-demand SI messages). In some cases, operations associated with requesting on-demand SI and/or signaling (e.g., transmitting, receiving) of the requested on-demand SI may be inefficient, such as increased signaling overhead and power consumption. For instance, some wireless communication systems may periodically transmit and/or receive a repetition of SI messages thereby utilizing greater communication resources (e.g., system bandwidth) and increased power consumption.

Various aspects of the present disclosure relate to enabling one or more UEs, base stations, network entities, or other communication equipment to support improvements to communicating (e.g., receiving, transmitting) on-demand SI. In some examples, one or more UEs, base stations, network entities, or other communication equipment may be configured to communicate (e.g., receive, transmit) on-demand SI at a lower rate (e.g., reduced recurrence, reduced frequency) compared to a default rate. Additionally, or alternatively, one or more UEs, base stations, network entities, or other communication equipment may be configured to communicate (e.g., receive, transmit) fewer on-demand SI. By reducing the rate (e.g., recurrence, frequency) and/or the number of SI messages, one or more UEs, base stations, network entities, or other communication equipment may experience reduced power consumption, decreased processor usage, reduce data usage, and increase overall system performance.

Aspects of the present disclosure are described in the context of a wireless communications system.

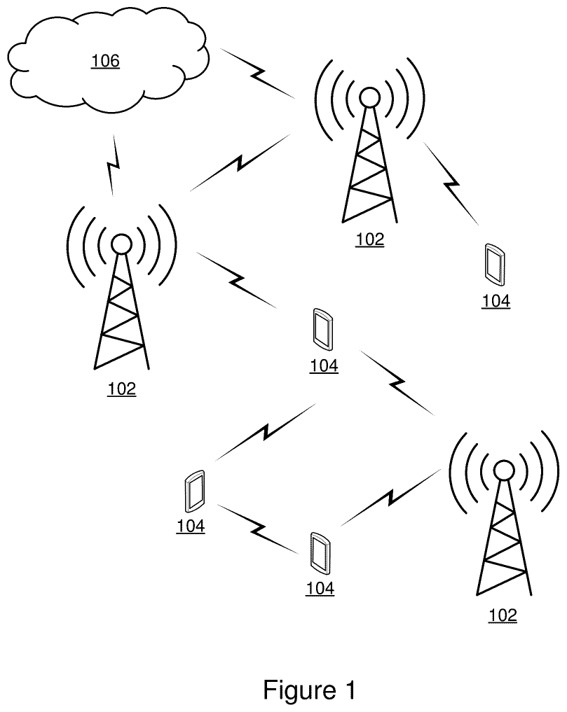

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a new radio (NR) network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with an NTN. In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a UE-to-UE interface (PC5 interface).

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., orthogonal frequency division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHZ-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

In 3GPP NR, a gNB may transmit a maximum of 64 synchronization signals and broadcast channels (e.g., SS/PBCH blocks (SSBs)) and a maximum of 64 corresponding copies of physical downlink control channel (PDCCH)/physical downlink shared channel (PDSCH) messages for system information block type 1 (SIB1) delivery in high frequency bands (e.g., 28 GHz). This may cause significant network energy consumption (e.g., even for very low traffic load conditions).

Network energy saving gains from on-demand SIB1 transmissions may be expected to be significant with low or empty traffic load conditions. Methods for adapting paging occasions and random access occasions with on-demand SIB1 transmission in an energy efficient 6th generation (6G) radio access network or beyond NR are described herein.

In 3GPP 5G NR, for a UE to access to a network, the UE may perform a cell search (e.g., time and frequency synchronization with a cell and detection of a physical layer cell identity of the cell), acquire essential system information of a cell such as a master information block (MIB) and SIB1, and select a suitable cell among detected cells.

For on-demand SIB1 delivery of a cell, a UE may transmit a request for SIB1 transmission such as an uplink (UL) wake-up signal and/or channel. The UE may transmit the request for the SIB1 transmission to the cell with the on-demand SIB1 delivery. Alternatively, the UE may transmit the request to another cell which does not employ on-demand SIB1 delivery. The UE may obtain the UL wake-up signal/channel configuration from the cell with the on-demand SIB1 delivery. Alternatively or additionally, the UE may obtain the UL wake-up signal/channel configuration from another cell not employing on-demand SIB1 delivery. The UE may receive on-demand SIB1 from the cell with the on-demand SIB1 delivery. Alternatively or additionally, the UE may receive on-demand SIB1 from another cell not employing on-demand SIB1 delivery.

In some systems, a UE may use discontinuous reception (DRX) in RRC_IDLE and RRC_INACTIVE states to reduce power consumption. A UE may monitor one paging occasion (PO) per DRX cycle. A PO may be a set of PDCCH monitoring occasions and may include multiple time slots (e.g., subframes or OFDM symbols) where paging DCI may be sent. One paging frame (PF) is one radio frame and may contain one or multiple POs or a starting point of a PO.

In multi-beam operations, a UE may assume that a same paging message and a same short message are repeated in all transmitted beams and thus selection of a beam for reception of the paging message and short message may be up to UE implementation. The paging message may be the same for both radio access network (RAN) initiated paging and core network (CN) initiated paging.

The PF and PO for paging may be determined by the following formula:

SFN for the PF is determined by: (SFN+PF_offset) mod T=(T div N)*(UE_ID mod N).

Index (i_s), indicating the index of the PO is determined by: i_s=floor (UE_ID/N) mod Ns.

The PDCCH monitoring occasions for paging may be determined according to pagingSearchSpace and firstPDCCH-MonitoringOccasionOfPO and nrofPDCCH-MonitoringOccasionPerSSB-InPO if configured. When SearchSpaceId=0 is configured for pagingSearchSpace, the PDCCH monitoring occasions for paging are same as for SIB1.

When SearchSpaceId=0 is configured for pagingSearchSpace, Ns is either 1 or 2. For Ns=1, there is only one PO which starts from the first PDCCH monitoring occasion for paging in the PF. For Ns=2, PO is either in the first half frame (i_s=0) or the second half frame (i_s=1) of the PF.

When SearchSpaceId other than 0 is configured for pagingSearchSpace, the UE may monitor the (i_s+1)th PO. A PO is a set of ‘S*X’ consecutive PDCCH monitoring occasions where ‘S’ is the number of actual transmitted SSBs determined according to ssb-PositionsInBurst in SIB1 and X is the nrofPDCCH-MonitoringOccasionPerSSB-InPO if configured or is equal to 1 otherwise. The [x*S+K]th PDCCH monitoring occasion for paging in the PO corresponds to the Kth transmitted SSB, where x=0, 1, . . . , X−1, K=1, 2, . . . , S. The PDCCH monitoring occasions for paging which do not overlap with UL symbols (determined according to tdd-UL-DL-ConfigurationCommon) are sequentially numbered from zero starting from the first PDCCH monitoring occasion for paging in the PF. When firstPDCCH-MonitoringOccasionOfPO is present, the starting PDCCH monitoring occasion number of (i_s+1)th PO is the (i_s+1)th value of the firstPDCCH-MonitoringOccasionOfPO parameter; otherwise, it is equal to i_s*S*X. If X>1, when the UE detects a PDCCH transmission addressed to P-RNTI within its PO, the UE is not required to monitor the subsequent PDCCH monitoring occasions for this PO. It should be noted that a PO associated with a PF may start in the PF or after the PF. Further, the PDCCH monitoring occasions for a PO may span multiple radio frames. When SearchSpaceId other than 0 is configured for paging-SearchSpace the PDCCH monitoring occasions for a PO can span multiple periods of the paging search space.

The following parameters may be used for the calculation of PF and i_s above: T: DRX cycle of the UE.

If the UE does not operate in extended DRX (eDRX), T is determined by the shortest of the UE specific DRX value configured by RRC (if any), the UE specific DRX value configured by upper layers (if any), and a default DRX value broadcast in system information. For L2 U2N Relay UE, T for a L2 U2N Remote UE is determined by the shortest of the UE specific DRX value provided in PC5-RRC signalling and a default DRX value broadcast in system information.

In RRC_IDLE state, if the UE operates in eDRX and eDRX is configured by upper layers, i.e., TeDRX, CN:
If TeDRX, CN is no longer than 1024 radio frames: T=TeDRX, CN;
else: During CN configured PTW, T is determined by the shortest of UE specific DRX value, if configured by upper layers, and the default DRX value broadcast in system information.

In an RRC_INACTIVE state, if the UE operates in eDRX and eDRX is configured by RRC, i.e., TeDRX, RAN (if any), and upper layers, i.e., TeDRX, CN: If both TeDRX, CN and used TeDRX, RAN are no longer than 1024 radio frames, T=min {TeDRX, RAN, TeDRX, CN}. If TeDRX, CN is no longer than 1024 radio frames and no TeDRX, RAN is configured or used, T is determined by the shortest of UE specific DRX value configured by RRC and TeDRX, CN.

If TeDRX, CN is longer than 1024 radio frames:
If TeDRX, RAN is not configured or used: During CN configured PTW, T is determined by the shortest of the UE specific DRX value configured by RRC, the UE specific DRX value configured by upper layers (if any), and a default DRX value broadcast in system information. Outside the CN configured PTW, T is determined by the UE specific DRX value configured by RRC;
else if used TeDRX, RAN is no longer than 1024 radio frames: During CN configured PTW, T is determined by the shortest of the UE specific DRX value, if configured by upper layers and TeDRX, RAN, and a default DRX value broadcast in system information. Outside the CN configured PTW, T is determined by TeDRX, RAN;
else if used TeDRX, RAN is longer than 1024 radio frames: During the overlapped part of CN configured PTW and RAN configured PTW, T is determined by the shortest of the UE specific DRX value configured by RRC, the UE specific DRX value configured by upper layers (if any), and a default DRX value broadcast in system information; During CN configured PTW and outside RAN configured PTW, T is determined by the shortest of the UE specific DRX value configured by upper layers (if any), and a default DRX value broadcast in system information; Outside CN configured PTW and during RAN configured PTW, T is determined by the UE specific DRX value configured by RRC. N: number of total paging frames in T; Ns: number of paging occasions for a PF; PF_offset: offset used for PF determination; UE_ID: If the UE operates in eDRX: 5G-S-TMSI mod 4096; else: 5G-S-TMSI mod 1024.

Parameters Ns, nAndPagingFrameOffset, nrofPDCCH-MonitoringOccasionPerSSB-InPO, and the length of default DRX Cycle are signaled in SIB1. The values of N and PF_offset are derived from the parameter nAndPagingFrameOffset. The parameter firstPDCCH-MonitoringOccasionOfPO is signalled in SIB1 for paging in the BWP configured by initialDownlinkBWP. For paging in a DL BWP other than the BWP configured by initialDownlinkBWP, the parameter first-PDCCH-MonitoringOccasionOfPO is signaled in the corresponding BWP configuration.

If the UE has no 5G-S-TMSI, for instance when the UE has not yet registered onto the network, the UE shall use as default identity UE_ID=0 in the PF and i_s formulas above.

5G-S-TMSI is a 48 bit long bit string as defined in TS 23.501. 5G-S-TMSI shall in the formula above be interpreted as a binary number where the left most bit represents the most significant bit.

In the RRC_INACTIVE state, if the UE supports inactiveStatePO-Determination and the network broadcasts ranPagingInIdlePO with value “true”, the UE shall use the same i_s as for RRC_IDLE state. Otherwise, the UE determines the i_s based on the parameters and formula above.

In the RRC_INACTIVE state, if used eDRX value configured by upper layers is no longer than 1024 radio frames, the UE shall use the same i_s as for RRC_IDLE state.

In the RRC_INACTIVE state, if used eDRX value configured by upper layers is longer than 1024 radio frames, during CN PTW, the UE shall use the same i_s as for RRC_IDLE state. Outside CN PTW, the UE shall use the i_s for RRC_INACTIVE state.

Prior to initiation of a physical random access procedure, a Layer 1 may receive from higher layers a set of SS/PBCH block indexes and provides to higher layers a corresponding set of reference signal received power (RSRP) measurements. Moreover, prior to initiation of the physical random access procedure, the layer 1 may receive from higher layers an indication to perform a Type-1 random access procedure, or a Type-2 random access procedure. Further, prior to initiation of the physical random access procedure, the layer 1 may receive the following information from the higher layers: the configuration of physical random access channel (PRACH) transmission parameters (e.g., PRACH preamble format, time resources, and frequency resources for PRACH transmission); and/or parameters for determining the root sequences and their cyclic shifts in the PRACH preamble sequence set (e.g., index to logical root sequence table, cyclic shift (Ncs), and set type (e.g., unrestricted, restricted set A, or restricted set B)).

From the physical layer perspective, the Type-1 L1 random access procedure may include the transmission of random access preamble (Msg1) in a PRACH, random access response (RAR) message with a PDCCH/PDSCH (Msg2), and when applicable, the transmission of a PUSCH scheduled by a RAR UL grant, and PDSCH for contention resolution.

From the physical layer perspective, the Type-2 L1 random access procedure may include the transmission of random access preamble in a PRACH and of a PUSCH (MsgA) and the reception of a RAR message with a PDCCH/PDSCH (MsgB), and when applicable, the transmission of a PUSCH scheduled by a fallback RAR UL grant, and PDSCH for contention resolution.

For the Type-1 random access procedure, a UE may be provided a number N of SS/PBCH block indexes associated with one PRACH occasion and a number R of contention based preambles per SS/PBCH block index per valid PRACH occasion by ssb-perRACH-OccasionAndCB-PreamblesPerSSB.

For the Type-2 random access procedure with common configuration of PRACH occasions with Type-1 random access procedure, the UE may be provided a number N of SS/PBCH block indexes associated with one PRACH occasion by ssb-perRACH-OccasionAndCB-PreamblesPerSSB and a number Q of contention based preambles per SS/PBCH block index per valid PRACH occasion by msgA-CB-PreamblesPerSSB-PerSharedRO. The PRACH transmission can be on a subset of PRACH occasions associated with a same SS/PBCH block index within an SSB-RO mapping cycle for a UE provided with a PRACH mask index by msgA-SSB-SharedRO-MaskIndex.

For the Type-2 random access procedure with separate configuration of PRACH occasions with the Type-1 random access procedure, the UE may be provided a number N of SS/PBCH block indexes associated with one PRACH occasion and a number R of contention based preambles per SS/PBCH block index per valid PRACH occasion by msgA-SSB-PerRACH-OccasionAndCB-PreamblesPerSSB when provided; otherwise, by ssb-perRACH-OccasionAndCB-PreamblesPerSSB.

For a random access procedure associated with a feature combination indicated by FeatureCombinationPreambles, the UE may be provided a number N of SS/PBCH block indexes associated with one PRACH occasion by ssb-perRACH-OccasionAndCB-PreamblesPerSSB or msgA-SSB-PerRACH-OccasionAndCB-PreamblesPerSSB when provided and a number S of contention based preambles per SS/PBCH block index per valid PRACH occasion by startPreambleForThisPartition and numberOfPreamblesPerSSB-ForThisPartition. The PRACH transmission may be on a subset of PRACH occasions associated with a same SS/PBCH block index within an SSB-RO mapping cycle for a UE provided with a PRACH mask index by ssb-SharedRO-MaskIndex.

For the Type-1 random access procedure, or for the Type-2 random access procedure with separate configuration of PRACH occasions from Type 1 random access procedure, if N<1, one SS/PBCH block index is mapped to 1/N consecutive valid PRACH occasions and R contention based preambles with consecutive indexes associated with the SS/PBCH block index per valid PRACH occasion start from preamble index 0. If N≥1, R contention based preambles with consecutive indexes associated with SS/PBCH block index n, 0≤n≤N−1, per valid PRACH occasion start from preamble index

$$n \cdot {N}_{preamble}^{total} / N where {N}_{preamble}^{total}$$

is provided by totalNumberOfRA-Preambles for Type-1 random access procedure, or by msgA-TotalNumberOfRA-Preambles for Type-2 random access procedure with separate configuration of PRACH occasions from a Type 1 random access procedure, and is an integer multiple of N.

For the Type-2 random access procedure with common configuration of PRACH occasions with the Type-1 random access procedure, if N<1, one SS/PBCH block index is mapped to 1/N consecutive valid PRACH occasions and Q contention based preambles with consecutive indexes associated with the SS/PBCH block index per valid PRACH occasion start from preamble index R. If N≥1, Q contention based preambles with consecutive indexes associated with SS/PBCH block index n, 0≤n≤N−1, per valid PRACH occasion start from preamble index

$$n \cdot {N}_{preamble}^{total} / N + R ,$$

where

$${N}_{preamble}^{total}$$

is provided by totalnumberOfRA-Preambles for Type-1 random access procedure.

SS/PBCH block indexes provided by ssb-PositionsInBurst in SIB1 or in ServingCellConfigCommon may be mapped to valid PRACH occasions in the following order: first, in increasing order of preamble indexes within a single PRACH occasion; second, in increasing order of frequency resource indexes for frequency multiplexed PRACH occasions; third, in increasing order of time resource indexes for time multiplexed PRACH occasions within a PRACH slot; and fourth, in increasing order of indexes for PRACH slots.

An association period, starting from frame 0, for mapping SS/PBCH block indexes to PRACH occasions is the smallest integer number in the set determined by the PRACH configuration period according Table 1 such that

$${N}_{T x}^{S S B}$$

SS/PBCH block indexes may be mapped at least once to the PRACH occasions within the association period, where a UE obtains

$${N}_{T x}^{S S B}$$

from the value of ssb-PositionsInBurst in SIB1 or in ServingCellConfigCommon. If after an integer number of SS/PBCH block indexes to PRACH occasions mapping cycles within the association period there is a set of PRACH occasions or PRACH preambles that are not mapped to N_{Tx}^{SSB} SS/PBCH block indexes, no SS/PBCH block indexes are mapped to the set of PRACH occasions or PRACH preambles. An association pattern period includes one or more association periods and may be determined so that a pattern between PRACH occasions and SS/PBCH block indexes repeats at most every 160 msec. PRACH occasions not associated with SS/PBCH block indexes after an integer number of association periods, if any, are not used for PRACH transmissions. Table 1 illustrates one mapping example.

TABLE 1
Mapping between PRACH configuration period and SS/PBCH
block to PRACH occasion association period

| PRACH configuration | Association period (number of |
|---|---|
| period (msec) | PRACH configuration periods) |
| 10 | {1, 2, 4, 8, 16} |
| 20 | {1, 2, 4, 8} |
| 40 | {1, 2, 4} |
| 80 | {1, 2} |
| 160 | {1} |

For a paired spectrum or a supplementary uplink band all PRACH occasions may be valid.

For an unpaired spectrum:
If a UE 104 is not provided tdd-UL-DL-ConfigurationCommon, a PRACH occasion in a PRACH slot is valid if it does not precede a SS/PBCH block in the PRACH slot and starts at least N_{gap} symbols after a last SS/PBCH block reception symbol, where N_{gap} is provided and, if channelAccessMode=“semiStatic” is provided, does not overlap with a set of consecutive symbols before the start of a next channel occupancy time where the UE 104 does not transmit. The candidate SS/PBCH block index of the SS/PBCH block corresponds to the SS/PBCH block index provided by ssb-PositionsInBurst in SIB1 or in ServingCellConfigCommon;
If a UE 104 is provided tdd-UL-DL-ConfigurationCommon, a PRACH occasion in a PRACH slot is valid if: it is within UL symbols, or it does not precede a SS/PBCH block in the PRACH slot and starts at least N_{gap} symbols after a last downlink symbol and at least N_{gap} symbols after a last SS/PBCH block symbol, where N_{gap} is provided, and if channelAccessMode=“semiStatic” is provided, does not overlap with a set of consecutive symbols before the start of a next channel occupancy time where there shall not be any transmissions, and the candidate SS/PBCH block index of the SS/PBCH block corresponds to the SS/PBCH block index provided by ssb-PositionsInBurst in SIB1 or in ServingCellConfigCommon.

In 5G NR, a modification period may be used to update SI. An updated SI message is broadcasted in a modification period following the one where the SI change indication is transmitted. The modification period boundaries may be defined by system frame number (SFN) values for which SFN mod m=0, where m is the number of radio frames comprising the modification period. The modification period may be configured by system information. If H-SFN is provided in SIB1, and UE 104 may be configured with eDRX, modification period boundaries may be defined by SFN values for which (H-SFN*1024+SFN) mod m=0. The modification period may be configured such as a multiple of default paging cycles.

For on-demand essential SI (e.g., SIB1) delivery of a cell, in one example, a MIB of the cell includes information of an on-demand SIB1 request resource configuration. Multiple SIB1 request resource configurations may be predefined, and a selection from the predefined configurations may be indicated via the MIB. For example, in a bitfield having two bits, the value ‘00’ may indicate periodic transmission of SIB1, and the values ‘01’, ‘10’, and ‘11’ may indicate first, second, and third on-demand SIB1 request resource configurations, respectively.

In certain examples, an on-demand essential SI request resource is a PRACH resource, and an on-demand essential SI request includes transmitting a Message 1 (Msg1) PRACH preamble in a PRACH occasion. In other examples, an on-demand essential SI request resource includes a PRACH resource and an associated physical uplink shared channel (PUSCH) resource, and an on-demand essential SI request includes transmitting Message A (MsgA) PRACH preamble on a PRACH occasion and transmitting MsgA PUSCH on the associated PUSCH occasion. The MsgA PUSCH may carry at least one of a UE 104 identity, a UE 104 type, and an access category.

If on-demand essential SI transmission is triggered, a network entity may transmit on-demand essential SI with a variable transmission repetition periodicity within an active on-demand essential SI transmission window. The active on-demand essential SI transmission window may be a time duration within which the on-demand essential SI transmission occurs. For example, transmission repetition periodicity may be 40 ms within the active on-demand essential SI transmission window of 160 ms.

In some examples, a UE 104 that has sent an on-demand essential SI request using an on-demand essential SI request resource may determine an on-demand essential SI transmission window based on the used on-demand essential SI request resource. The UE 104 may perform PDCCH blind decoding on configured PDCCH monitoring occasions within the on-demand essential SI transmission window to identity whether or not the on-demand essential SI transmission is triggered. In one example, a DCI format sent on the configured PDCCH monitoring occasions explicitly indicates triggering or rejection of the request. When the DCI format indicates the rejection of the request, the UE 104 does not perform retransmission of the request. In another example, a DCI format scheduling a PDSCH for the on-demand essential SI implicitly indicates triggering. If the UE 104 does not detect the DCI format, the UE 104 performs retransmission of the request until reaching a maximum number of request transmissions.

If on-demand essential SI transmission is triggered, a network entity transmits an indication that the on-demand essential SI transmission is triggered in multiple ways targeting UEs 104 in different states.

In one embodiment, an indication that on-demand essential SI transmission is triggered is sent via a PBCH (e.g., PBCH payload and/or a PBCH DMRS sequence). A UE 104, which has detected synchronization signals of a cell and has received a PBCH of the cell but has not yet camped on the cell, may determine based on the received PBCH whether to request the on-demand essential SI or to directly acquire the currently broadcast on-demand essential SI. If the UE 104 receives the indication that on-demand essential SI transmission is triggered, the UE 104 may be prohibited from sending an on-demand essential SI request during an active on-demand essential SI transmission window and additionally for a configured or predefined duration after an end of the active on-demand essential SI transmission window.

In one implementation, the UE 104 receives at least part of information of an active on-demand essential SI transmission window via the PBCH. In one example, a bitfield in the PBCH payload indicates a configured on-demand essential SI request resource (e.g., a PRACH occasion index within a PRACH configuration period) associated with the active on-demand essential SI transmission window or indicates that on-demand essential SI transmission is not triggered. The UE 104 may obtain information of the active on-demand essential SI transmission window (e.g., a slot offset and a starting radio frame number) based on the indicated on-demand essential SI request resource. In another example, multiple sets of on-demand essential SI transmission windows and corresponding multiple on-demand essential SI request resource configurations, each set of transmission windows corresponding to each request resource configuration, are predefined. A bitfield in the PBCH payload may indicate an active on-demand essential SI transmission window selected from a set of on-demand essential SI transmission windows associated with a configured on-demand essential SI request resource configuration or may indicate that on-demand essential SI transmission is not triggered.

In another embodiment, while a UE 104 camps on or is connected with a cell that has on-demand essential SI, the UE 104 may monitor paging DCI or paging early indication (PEI) DCI indicating whether on-demand essential SI transmission including new and/or updated SI contents is triggered and, if triggered, may indicate an active on-demand essential SI transmission window. If the UE 104 receives information of an active on-demand essential SI transmission window, the UE 104 may re-acquire the on-demand essential SI in the indicated active on-demand essential SI transmission window. In one example, a bitfield in PEI DCI or paging DCI may indicate an active on-demand essential SI transmission window selected from a configured set of on-demand essential SI transmission windows or no change in on-demand essential SI. When the UE 104 does not detect paging DCI or PEI DCI, the UE 104 may assume no change in on-demand essential SI.

In one implementation, a UE 104 camping on or being connected with a cell that has on-demand essential SI transmission (e.g., a UE 104 monitoring paging DCI and/or PEI DCI on the cell with on-demand essential SI) is prohibited from sending an on-demand essential SI request for the cell.

In yet another embodiment, paging DCI or PEI DCI indicates whether or not on-demand essential SI transmission is newly triggered, and if triggered, whether the triggered on-demand essential SI transmission includes new/updated SI or SI the same as one in the previous triggering. Additionally, paging DCI or PEI DCI may indicate whether the cell continues to be operated in the on-demand essential SI transmission mode or switches to periodic transmission of essential SI. In one example, in a bitfield having two bits in PEI DCI or paging DCI, the values ‘00’, ‘01’, ‘10’, and ‘11’ indicate no triggering, triggering without SI change, triggering with SI change, and switching to periodic transmission of essential SI, respectively. When the UE 104 does not detect paging DCI or PEI DCI, the UE 104 may assume no triggering of on-demand essential SI transmission and that the cell continues to be operated in the on-demand essential SI transmission mode.

If a UE 104 receives an indication of ‘triggering with SI change’, the UE 104 may determine an active on-demand essential SI transmission window and may re-acquire the new/updated on-demand essential SI in the active on-demand essential SI transmission window. In one implementation, the UE 104 may determine an active on-demand essential SI transmission window (e.g., a starting radio frame) based on a paging cycle/paging frame of a paging occasion or a reference frame of a PEI occasion where the UE 104 detected paging DCI or PEI DCI indicating the triggering.

In one implementation, when a UE 104 receives an indication of ‘switching to periodic transmission of essential SI’ in paging DCI or PEI DCI, the UE 104 may re-acquire essential SI in the next modification period.

If at least part of essential SI of a cell (e.g., SIB1) is transmitted on an on-demand basis upon receiving a request from a UE 104 and/or from a neighboring cell, some UEs 104 may camp on the cell after the on-demand essential SI of the cell is transmitted. Thus, paging occasions and RACH occasions may need to be active after transmission of the on-demand essential SI so that the UEs 104 camping on the cell can receive paging and can access the cell if needed. When some time elapses (e.g., 1 second) after the latest on-demand essential SI transmission, the UE 104 may leave the cell and may re-select a different cell depending on its radio condition and mobility. Accordingly, the cell may transition paging and/or RACH configurations into a network energy saving mode.

In one embodiment, a network entity may apply a first set of paging configuration parameters upon transmitting on-demand essential SI of a cell. The network entity may switch to a second set of paging configuration parameters after a first duration elapses since the latest transmission of on-demand essential SI of the cell, or, alternatively, since an end of the latest active on-demand essential SI transmission window, or, alternatively, since an end of the latest active SI modification period. In one implementation, the first duration is predefined. In another implementation, an indication of the first duration is included in the essential SI. Additionally, or alternatively, the network entity applies a first set of RACH configuration parameters for the cell upon transmitting the on-demand essential SI of the cell. The network entity may switch to a second set of RACH configuration parameters for the cell after a second duration elapses since the latest transmission of the on-demand essential SI of the cell, or, alternatively, since an end of the latest active on-demand essential SI transmission window, or, alternatively, since an end of the latest active SI modification period. The second duration may be predefined, or an indication of the second duration may be included in the essential SI. In an implementation, the first duration is same as the second duration. In another implementation, the first duration is different from the second duration. In a further implementation, the second set of paging configuration parameters and/or the second set of RACH configuration parameters are applied if the cell continues to be operated in the on-demand essential SI transmission mode.

In one implementation, the on-demand essential SI includes information of the first set of paging configuration parameters and the second set of paging configuration parameters. In another implementation, a UE 104 may derive at least a part of the second set of paging configuration parameters based on the first set of paging configuration parameters.

In certain implementations, the network entity configures a smaller number of paging occasions in each time interval for the cell after the first duration elapses since the latest transmission of the on-demand essential SI of the cell. The number of paging occasions may be reduced by increasing a paging cycle, decreasing the number of paging frames per paging cycle, and/or decreasing the number of paging occasions per paging frame. In one example, a first default (e.g., cell-specific) DRX cycle in the first set of paging configuration parameters is shorter than a second default DRX cycle in the second set of paging configuration parameters. In another example, a first number of paging frames per paging cycle in the first set of paging configuration parameters is larger than a second number of paging frames per paging cycle in the second set of paging configuration parameters. In yet another example, a first number of paging occasions per paging frame in the first set of paging configuration parameters is larger than a second number of paging occasions per paging frame in the second set of paging configuration parameters.

In one implementation, the on-demand essential SI includes information of the first set of RACH configuration parameters and the second set of RACH configuration parameters. In another implementation, a UE 104 may derive at least a part of the second set of RACH configuration parameters based on the first set of RACH configuration parameters.

In some implementations, the network entity configures a smaller number of RACH occasions in each time interval for the cell after the second duration elapses since the latest transmission of the on-demand essential SI of the cell, or, alternatively, since an end of the latest active on-demand essential SI transmission window, or, alternatively, since an end of the latest active SI modification period. In one example, the network entity sends a PRACH mask index and activates only PRACH occasions indicated by the PRACH mask index after the second duration elapses. For example, the PRACH occasions may be mapped consecutively per corresponding SS/PBCH block index. The indexing of the PRACH occasion indicated by the PRACH mask index value may be reset per mapping cycle of consecutive PRACH occasions per SS/PBCH block index. The ordering of the PRACH occasions may be: first, in increasing order of frequency resource indexes for frequency multiplexed PRACH occasions, second, in increasing order of time resource indexes for time multiplexed PRACH occasions within a PRACH slot, and third, in increasing order of indexes for PRACH slots.

In one implementation, a network entity may deactivate at least a part of paging occasions of a cell after a first duration elapses since the latest transmission of on-demand essential SI of the cell or, alternatively, since an end of the latest active on-demand essential SI transmission window, or, alternatively, since an end of the latest active SI modification period. Additionally, or alternatively, the network entity may deactivate at least a part of RACH occasions of the cell after a second duration elapses since the latest transmission of the on-demand essential SI of the cell or, alternatively, since an end of the latest active on-demand essential SI transmission window, or, alternatively, since an end of the latest active SI modification period.

In one embodiment, a UE 104 applies a first set of paging configuration parameters to determine its own paging occasion upon receiving on-demand essential SI of a cell. The UE 104 applies a second set of paging configuration parameters after a first duration elapses since the latest scheduled/expected transmission of on-demand essential SI of the cell, or, alternatively, since an end of the latest active on-demand essential SI transmission window of the cell, or, alternatively, since an end of the latest active SI modification period. In one implementation, the first duration is predefined. In another implementation, an indication of the first duration is included in the essential SI. Additionally, or alternatively, the UE 104 applies a first set of RACH configuration parameters for the cell upon receiving the on-demand essential SI of the cell. The UE 104 may apply a second set of RACH configuration parameters for the cell after a second duration elapses since the latest scheduled/expected transmission of on-demand essential SI of the cell, or, alternatively, since an end of the latest active on-demand essential SI transmission window of the cell, or, alternatively, since an end of the latest active SI modification period. The second duration may be predefined, or an indication of the second duration may be included in the essential SI. In an implementation, the first duration is same as the second duration. In another implementation, the first duration is different from the second duration. In an implementation, the second set of paging configuration parameters and/or the second set of RACH configuration parameters are applied if the cell continues to be operated in the on-demand essential SI transmission mode.

In one implementation, a UE 104 assumes that at least part of paging occasions of a cell is deactivated after a first duration elapses since the latest scheduled/expected transmission of on-demand essential SI of the cell or, alternatively, since an end of the latest active on-demand essential SI transmission window, or, alternatively, since an end of the latest active SI modification period. Additionally, or alternatively, the UE 104 may assume that at least a part of RACH occasions of the cell is deactivated after a second duration elapses since the latest transmission of the on-demand essential SI of the cell or, alternatively, since an end of the latest active on-demand essential SI transmission window, or, alternatively, since an end of the latest active SI modification period.

In another embodiment, a UE 104 may set or reset a first timer value to a first duration upon receiving an indication that an on-demand essential SI transmission is newly triggered. The UE 104 may apply a first set of paging configuration parameters while the first timer is running. The UE 104 may apply a second set of paging configuration parameters upon expiry of the first timer. Alternatively, or additionally, the UE 104 may set or reset a second timer value to a second duration upon receiving an indication that an on-demand essential SI transmission is newly triggered. The UE 104 may apply a first set of RACH configuration parameters while the second timer is running. The UE 104 may apply a second set of RACH configuration parameters upon expiry of the second timer.

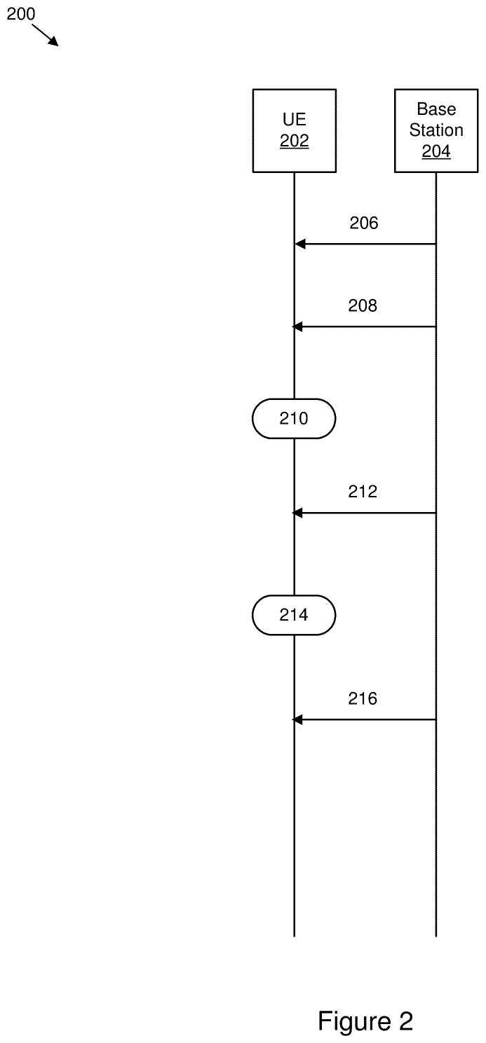

FIG. 2 illustrates an example of a process flow diagram 200 that supports energy saving associated with communication of on-demand SI in accordance with aspects of the present disclosure. The process flow diagram 200 may implement various aspects of the present disclosure described herein. For example, the process flow diagram 200 may include a UE 202 and a base station 204, which may be examples of UEs and base stations as described herein. In the following description of the process flow diagram 200, the operations between the UE 202 and/or the base station 204 may be performed in different orders or at different times. Some operations may also be omitted, or other operations may be added. Although the UE 202 and/or the base station 204 are shown perform the operations of the process flow diagram 200, some aspects of some operations may also be performed by other entities of the process flow diagram 200 or by entities that are not shown in the process flow diagram 200, or any combination thereof.

At 206, the base station 204 may transmit, and the UE 202 may receive, an indication that a first transmission of on-demand essential SI is triggered in a cell (e.g., associated with the base station 204). At 208, the base station 204 may transmit, and the UE 202 may receive, the on-demand essential SI during a transmission window associated with the first transmission of the on-demand essential SI. The received on-demand essential SI may be associated with the cell.

At 210, the UE 202 may monitor for the paging DCI in the cell (e.g., associated with the base station 240) according to the first paging configuration. At 212, the base station 204 may transmit, and the UE 202 may receive, a paging DCI in the cell (e.g., associated with the base station 240) according to a first paging configuration.

At 214, the UE 202 may monitor the paging DCI in the cell according to the second paging configuration and after the threshold duration elapses following the transmission window (e.g., after an ending of the transmission window) associated with the cell. At 216, the base station 204 may transmit, and the UE 202 may receive, a paging DCI in the cell (e.g., associated with the base station 240) according to a second paging configuration and after a threshold duration elapses following the transmission window (e.g., after an ending of the transmission window) associated with the cell.

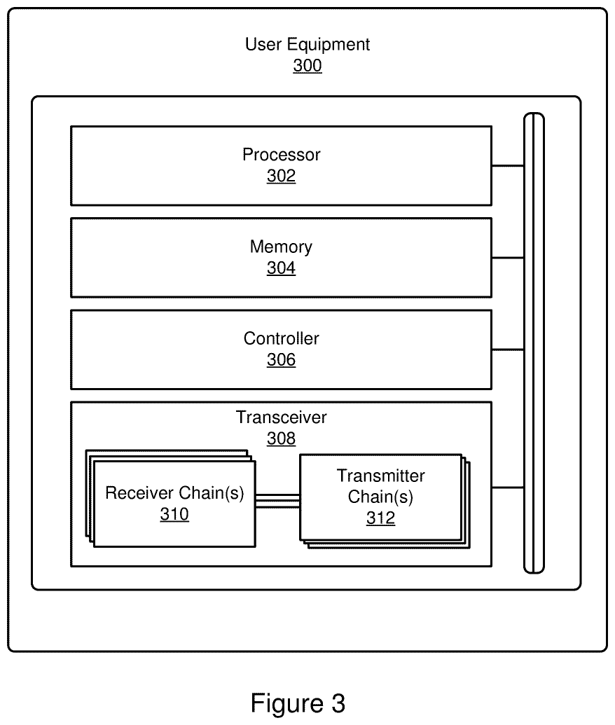

FIG. 3 illustrates an example of a UE 300 in accordance with aspects of the present disclosure. The UE 300 may include a processor 302, a memory 304, a controller 306, and a transceiver 308. The processor 302, the memory 304, the controller 306, or the transceiver 308, or various combinations thereof or various components thereof may be examples of means for performing various aspects of the present disclosure as described herein. These components may be coupled (e.g., operatively, communicatively, functionally, electronically, electrically) via one or more interfaces.

The processor 302, the memory 304, the controller 306, or the transceiver 308, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 302 may include an intelligent hardware device (e.g., a general-purpose processor, a DSP, a CPU, an ASIC, a field programmable gate array (FPGA), or any combination thereof). In some implementations, the processor 302 may be configured to operate the memory 304. In some other implementations, the memory 304 may be integrated into the processor 302. The processor 302 may be configured to execute computer-readable instructions stored in the memory 304 to cause the UE 300 to perform various functions of the present disclosure.

The memory 304 may include volatile or non-volatile memory. The memory 304 may store computer-readable, computer-executable code including instructions when executed by the processor 302 cause the UE 300 to perform various functions described herein. The code may be stored in a non-transitory computer-readable medium such the memory 304 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 302 and the memory 304 coupled with the processor 302 may be configured to cause the UE 300 to perform one or more of the functions described herein (e.g., executing, by the processor 302, instructions stored in the memory 304). For example, the processor 302 may support wireless communication at the UE 300 in accordance with examples as disclosed herein. For example, the processor 302 coupled with the memory 304 may be configured to cause the UE 300 to: receive an indication that a first transmission of on-demand essential SI is triggered in a cell, wherein the transmission of on-demand essential system comprises on-demand essential SI comprising first essential SI, receive the on-demand essential SI during a transmission window associated with the first transmission of on-demand essential SI, monitor for paging DCI associated with the cell according to a first paging configuration, and monitor for paging DCI associated with the cell according to a second paging configuration and after a threshold duration elapses following the transmission window.

The controller 306 may manage input and output signals for the UE 300. The controller 306 may also manage peripherals not integrated into the UE 300. In some implementations, the controller 306 may utilize an operating system such as iOS®, ANDROID®, WINDOWS®, or other operating systems. In some implementations, the controller 306 may be implemented as part of the processor 302.

In some implementations, the UE 300 may include at least one transceiver 308. In some other implementations, the UE 300 may have more than one transceiver 308. The transceiver 308 may represent a wireless transceiver. The transceiver 308 may include one or more receiver chains 310, one or more transmitter chains 312, or a combination thereof.

A receiver chain 310 may be configured to receive signals (e.g., control information, data, packets) over a wireless medium. For example, the receiver chain 310 may include one or more antennas for receive the signal over the air or wireless medium. The receiver chain 310 may include at least one amplifier (e.g., a low-noise amplifier (LNA)) configured to amplify the received signal. The receiver chain 310 may include at least one demodulator configured to demodulate the receive signal and obtain the transmitted data by reversing the modulation technique applied during transmission of the signal. The receiver chain 310 may include at least one decoder for decoding the processing the demodulated signal to receive the transmitted data.

A transmitter chain 312 may be configured to generate and transmit signals (e.g., control information, data, packets). The transmitter chain 312 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 312 may also include at least one power amplifier configured to amplify the modulated signal to an appropriate power level suitable for transmission over the wireless medium. The transmitter chain 312 may also include one or more antennas for transmitting the amplified signal into the air or wireless medium.

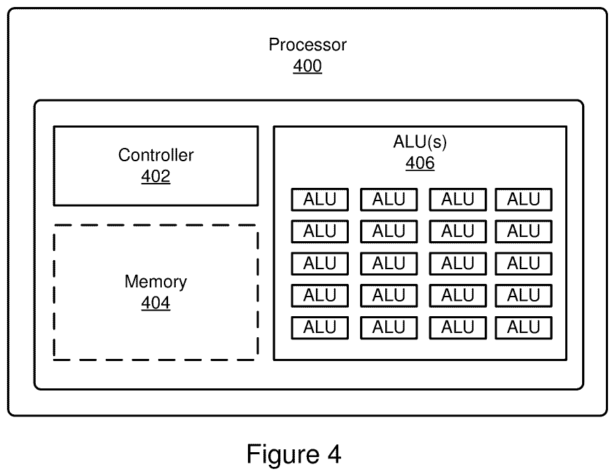

FIG. 4 illustrates an example of a processor 400 in accordance with aspects of the present disclosure. The processor 400 may be an example of a processor configured to perform various operations in accordance with examples as described herein. The processor 400 may include a controller 402 configured to perform various operations in accordance with examples as described herein. The processor 400 may optionally include at least one memory 404, which may be, for example, an L1/L2/L3 cache. Additionally, or alternatively, the processor 400 may optionally include one or more arithmetic-logic units (ALUs) 406. One or more of these components may be in electronic communication or otherwise coupled (e.g., operatively, communicatively, functionally, electronically, electrically) via one or more interfaces (e.g., buses).

The processor 400 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 400) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 402 may be configured to manage and coordinate various operations (e.g., signaling, receiving, obtaining, retrieving, transmitting, outputting, forwarding, storing, determining, identifying, accessing, writing, reading) of the processor 400 to cause the processor 400 to support various operations in accordance with examples as described herein. For example, the controller 402 may operate as a control unit of the processor 400, generating control signals that manage the operation of various components of the processor 400. These control signals include enabling or disabling functional units, selecting data paths, initiating memory access, and coordinating timing of operations.

The controller 402 may be configured to fetch (e.g., obtain, retrieve, receive) instructions from the memory 404 and determine subsequent instruction(s) to be executed to cause the processor 400 to support various operations in accordance with examples as described herein. The controller 402 may be configured to track memory address of instructions associated with the memory 404. The controller 402 may be configured to decode instructions to determine the operation to be performed and the operands involved. For example, the controller 402 may be configured to interpret the instruction and determine control signals to be output to other components of the processor 400 to cause the processor 400 to support various operations in accordance with examples as described herein. Additionally, or alternatively, the controller 402 may be configured to manage flow of data within the processor 400. The controller 402 may be configured to control transfer of data between registers, arithmetic logic units (ALUs), and other functional units of the processor 400.

The memory 404 may include one or more caches (e.g., memory local to or included in the processor 400 or other memory, such RAM, ROM, DRAM, SDRAM, SRAM, MRAM, flash memory, etc. In some implementations, the memory 404 may reside within or on a processor chipset (e.g., local to the processor 400). In some other implementations, the memory 404 may reside external to the processor chipset (e.g., remote to the processor 400).

The memory 404 may store computer-readable, computer-executable code including instructions that, when executed by the processor 400, cause the processor 400 to perform various functions described herein. The code may be stored in a non-transitory computer-readable medium such as system memory or another type of memory. The controller 402 and/or the processor 400 may be configured to execute computer-readable instructions stored in the memory 404 to cause the processor 400 to perform various functions. For example, the processor 400 and/or the controller 402 may be coupled with or to the memory 404, the processor 400, the controller 402, and the memory 404 may be configured to perform various functions described herein. In some examples, the processor 400 may include multiple processors and the memory 404 may include multiple memories. One or more of the multiple processors may be coupled with one or more of the multiple memories, which may, individually or collectively, be configured to perform various functions herein.

The one or more ALUs 406 may be configured to support various operations in accordance with examples as described herein. In some implementations, the one or more ALUs 406 may reside within or on a processor chipset (e.g., the processor 400). In some other implementations, the one or more ALUs 406 may reside external to the processor chipset (e.g., the processor 400). One or more ALUs 406 may perform one or more computations such as addition, subtraction, multiplication, and division on data. For example, one or more ALUs 406 may receive input operands and an operation code, which determines an operation to be executed. One or more ALUs 406 be configured with a variety of logical and arithmetic circuits, including adders, subtractors, shifters, and logic gates, to process and manipulate the data according to the operation. Additionally, or alternatively, the one or more ALUs 406 may support logical operations such as AND, OR, exclusive-OR (XOR), not-OR (NOR), and not-AND (NAND), enabling the one or more ALUs 406 to handle conditional operations, comparisons, and bitwise operations.

The processor 400 may support wireless communication in accordance with examples as disclosed herein. The processor 400 may be configured to or operable to support a means for: receiving an indication that a first transmission of on-demand essential SI is triggered in a cell, wherein the transmission of on-demand essential system comprises on-demand essential SI comprising first essential SI, receiving the on-demand essential SI during a transmission window associated with the first transmission of on-demand essential SI, monitoring for paging DCI associated with the cell according to a first paging configuration, and monitoring for paging DCI associated with the cell according to a second paging configuration and after a threshold duration elapses following the transmission window.

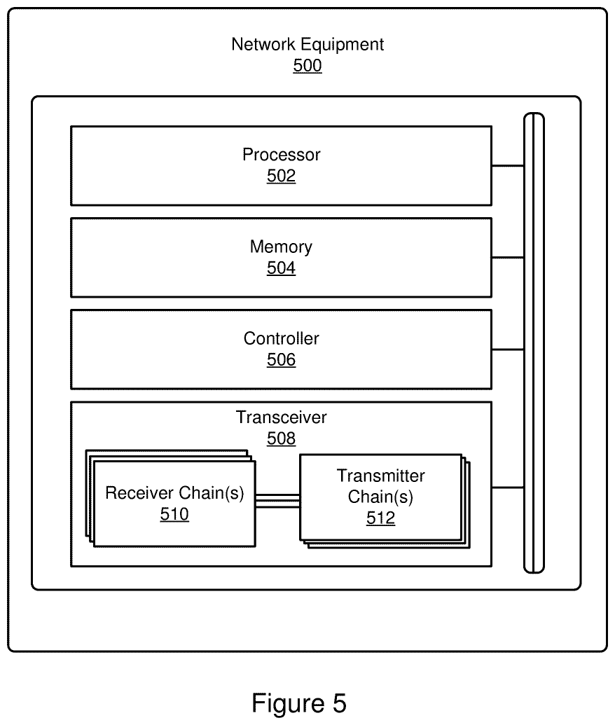

FIG. 5 illustrates an example of a NE 500 in accordance with aspects of the present disclosure. The NE 500 may include a processor 502, a memory 504, a controller 506, and a transceiver 508. The processor 502, the memory 504, the controller 506, or the transceiver 508, or various combinations thereof or various components thereof may be examples of means for performing various aspects of the present disclosure as described herein. These components may be coupled (e.g., operatively, communicatively, functionally, electronically, electrically) via one or more interfaces.

The processor 502, the memory 504, the controller 506, or the transceiver 508, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 502 may include an intelligent hardware device (e.g., a general-purpose processor, a DSP, a CPU, an ASIC, an FPGA, or any combination thereof). In some implementations, the processor 502 may be configured to operate the memory 504. In some other implementations, the memory 504 may be integrated into the processor 502. The processor 502 may be configured to execute computer-readable instructions stored in the memory 504 to cause the NE 500 to perform various functions of the present disclosure. For example, the processor 502 coupled with the memory 504 may be configured to cause the NE 500 to: transmit an indication that a first transmission of on-demand essential SI is triggered in a cell, wherein the transmission of on-demand essential system comprises on-demand essential SI comprising first essential SI, transmit the on-demand essential SI during a transmission window associated with the first transmission of on-demand essential SI, transmit paging DCI associated with the cell according to a first paging configuration, and transmit paging DCI associated with the cell according to a second paging configuration and after a threshold duration elapses following the transmission window.

The memory 504 may include volatile or non-volatile memory. The memory 504 may store computer-readable, computer-executable code including instructions when executed by the processor 502 cause the NE 500 to perform various functions described herein. The code may be stored in a non-transitory computer-readable medium such the memory 504 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 502 and the memory 504 coupled with the processor 502 may be configured to cause the NE 500 to perform one or more of the functions described herein (e.g., executing, by the processor 502, instructions stored in the memory 504). For example, the processor 502 may support wireless communication at the NE 500 in accordance with examples as disclosed herein.

The controller 506 may manage input and output signals for the NE 500. The controller 506 may also manage peripherals not integrated into the NE 500. In some implementations, the controller 506 may utilize an operating system such as iOS®, ANDROID®, WINDOWS®, or other operating systems. In some implementations, the controller 506 may be implemented as part of the processor 502.

In some implementations, the NE 500 may include at least one transceiver 508. In some other implementations, the NE 500 may have more than one transceiver 508. The transceiver 508 may represent a wireless transceiver. The transceiver 508 may include one or more receiver chains 510, one or more transmitter chains 512, or a combination thereof.

A receiver chain 510 may be configured to receive signals (e.g., control information, data, packets) over a wireless medium. For example, the receiver chain 510 may include one or more antennas for receive the signal over the air or wireless medium. The receiver chain 510 may include at least one amplifier (e.g., a low-noise amplifier (LNA)) configured to amplify the received signal. The receiver chain 510 may include at least one demodulator configured to demodulate the receive signal and obtain the transmitted data by reversing the modulation technique applied during transmission of the signal. The receiver chain 510 may include at least one decoder for decoding the processing the demodulated signal to receive the transmitted data.

A transmitter chain 512 may be configured to generate and transmit signals (e.g., control information, data, packets). The transmitter chain 512 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 512 may also include at least one power amplifier configured to amplify the modulated signal to an appropriate power level suitable for transmission over the wireless medium. The transmitter chain 512 may also include one or more antennas for transmitting the amplified signal into the air or wireless medium.

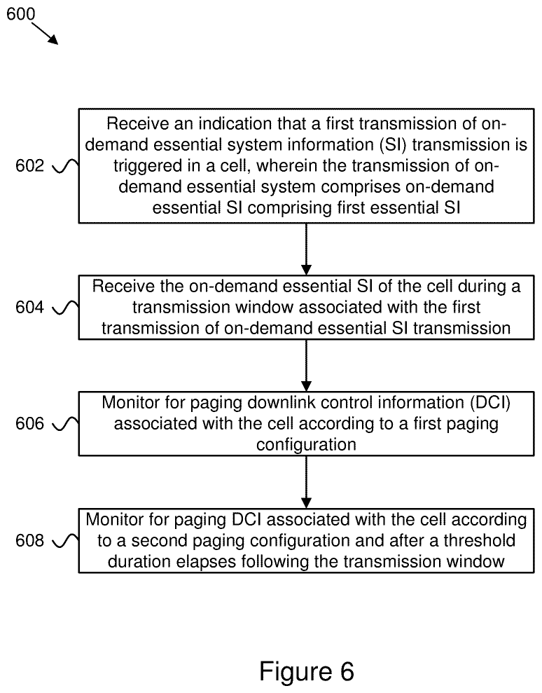

FIG. 6 illustrates a flowchart of a method 600 in accordance with aspects of the present disclosure. The operations of the method 600 may be implemented by a UE as described herein. In some implementations, a UE 300 may execute a set of instructions to control the function elements of a processor to perform the described functions.

At 602, the method may include receiving an indication that a first transmission of on-demand essential system information (SI) is triggered in a cell, wherein the transmission of on-demand essential system comprises on-demand essential SI comprising first essential SI. The operations of 602 may be performed in accordance with examples as described herein. In some implementations, aspects of the operations of 602 may be performed by a UE as described with reference to FIG. 3.

At 604, the method may include receiving the on-demand essential SI during a transmission window associated with the first transmission of on-demand essential SI. The operations of 604 may be performed in accordance with examples as described herein. In some implementations, aspects of the operations of 604 may be performed by a UE as described with reference to FIG. 3.

At 606, the method may include monitoring for paging downlink control information (DCI) associated with the cell according to a first paging configuration. The operations of 606 may be performed in accordance with examples as described herein. In some implementations, aspects of the operations of 606 may be performed by a UE as described with reference to FIG. 3.

At 608, the method may include monitoring for paging DCI associated with the cell according to a second paging configuration and after a threshold duration elapses following the transmission window. The operations of 608 may be performed in accordance with examples as described herein. In some implementations, aspects of the operations of 608 may be performed by a UE as described with reference to FIG. 3.

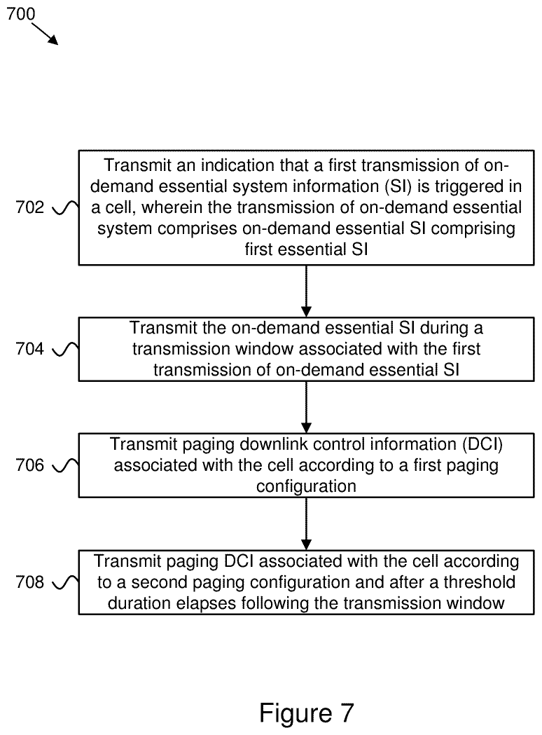

FIG. 7 illustrates a flowchart of another method 700 in accordance with aspects of the present disclosure. The operations of the method 700 may be implemented by a NE as described herein. In some implementations, a NE 500 may execute a set of instructions to control the function elements of a processor to perform the described functions.

At 702, the method may include transmitting an indication that a first transmission of on-demand essential system information (SI) is triggered in a cell, wherein the transmission of on-demand essential system comprises on-demand essential SI comprising first essential SI. The operations of 702 may be performed in accordance with examples as described herein. In some implementations, aspects of the operations of 702 may be performed by a NE as described with reference to FIG. 5.

At 704, the method may include transmitting the on-demand essential SI during a transmission window associated with the first transmission of on-demand essential SI. The operations of 704 may be performed in accordance with examples as described herein. In some implementations, aspects of the operations of 704 may be performed by a NE as described with reference to FIG. 5.

At 706, the method may include transmitting paging downlink control information (DCI) associated with the cell according to a first paging configuration. The operations of 706 may be performed in accordance with examples as described herein. In some implementations, aspects of the operations of 706 may be performed by a NE as described with reference to FIG. 5.

At 708, the method may include transmitting paging DCI associated with the cell according to a second paging configuration and after a threshold duration elapses following the transmission window. The operations of 708 may be performed in accordance with examples as described herein. In some implementations, aspects of the operations of 708 may be performed by a NE as described with reference to FIG. 5.

It should be noted that the methods described herein describe possible implementations, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
at least one memory; and
at least one processor coupled with the at least one memory and configured to cause the UE to:
receive an indication that a first transmission of on-demand essential system information (SI) is triggered in a cell, wherein the transmission of on-demand essential system comprises on-demand essential SI comprising first essential SI;
receive the on-demand essential SI during a transmission window associated with the first transmission of on-demand essential SI;
monitor for paging downlink control information (DCI) associated with the cell according to a first paging configuration; and
monitor for paging DCI associated with the cell according to a second paging configuration and after a threshold duration elapses following the transmission window.

2. The UE of claim 1, wherein the indication that the first transmission of on-demand essential SI is received via a physical broadcast channel (PBCH).

3. The UE of claim 1, wherein the at least one processor is configured to cause the UE to receive information indicating the threshold duration, the first paging configuration, and the second paging configuration.

4. The UE of claim 1, wherein the at least one processor is configured to cause the UE to:
receive configuration information associated with the transmission window; and
determine the transmission window based on the received information.

5. The UE of claim 1, wherein the paging DCI indicates whether a second transmission of on-demand essential SI is triggered in the cell, wherein the paging DCI indicates whether the second transmission of on-demand essential SI comprises the first essential SI or a second essential SI different than the first essential SI, wherein the paging DCI indicates a mode of operation associated with the cell, and wherein the mode of operation associated with the cell comprises an on-demand essential SI transmission mode or a periodic essential SI transmission mode.

6. The UE of claim 5, wherein the at least one processor is configured to cause the UE to re-receive the first essential SI or the second essential SI during a next occasion based at least in part on an indication of the mode of operation associated with the cell.

7. The UE of claim 1, wherein the at least one processor is configured to cause the UE to:
monitor for a paging early indication (PEI) DCI; and
detecting the PEI DCI based on the monitoring,
wherein the PEI DCI indicates whether a second transmission of on-demand essential SI transmission is triggered in the cell,
wherein the PEI DCI indicates whether the second transmission of on-demand essential SI comprises the first essential SI or a second essential SI different than the first essential SI, and
wherein the PEI DCI indicates a mode of operation associated with the cell, and
wherein the mode of operation associated with the cell comprises an on-demand essential SI transmission mode or a periodic essential SI transmission mode.

8. The UE of claim 1, wherein the at least one processor is configured to cause the UE to:
set a first set of random access channel (RACH) configuration parameters for the cell; and
set a second set of RACH configuration parameters for the cell after a second threshold duration elapses following the transmission window.

9. The UE of claim 8, wherein the at least one processor is configured to cause the UE to receive information indicating one or more of the second threshold duration, the first set of RACH configuration parameters, or the second set of RACH configuration parameters.

10. A processor for wireless communication, comprising:
at least one controller coupled with at least one memory and configured to cause the processor to:
receive an indication that a first transmission of on-demand essential system information (SI) is triggered in a cell, wherein the transmission of on-demand essential system comprises on-demand essential SI comprising first essential SI;
receive the on-demand essential SI during a transmission window associated with the first transmission of on-demand essential SI;
monitor for paging downlink control information (DCI) associated with the cell according to a first paging configuration; and
monitor for paging DCI associated with the cell according to a second paging configuration and after a threshold duration elapses following the transmission window.

11. The processor of claim 10, wherein the indication that the first transmission of on-demand essential SI is received via a physical broadcast channel (PBCH).

12. The processor of claim 10, wherein the at least one controller is configured to cause the processor to receive information indicating the threshold duration, the first paging configuration, and the second paging configuration.

13. The processor of claim 10, wherein the at least one controller is configured to cause the processor to:
receive configuration information associated with the transmission window; and
determine the transmission window based on the received information.

14. A method at a user equipment (UE), the method comprising:
receiving an indication that a first transmission of on-demand essential system information (SI) is triggered in a cell, wherein the transmission of on-demand essential system comprises on-demand essential SI comprising first essential SI;
receiving the on-demand essential SI during a transmission window associated with the first transmission of on-demand essential SI;
monitoring for paging downlink control information (DCI) associated with the cell according to a first paging configuration; and
monitoring for paging DCI associated with the cell according to a second paging configuration and after a threshold duration elapses following the transmission window.

15. A base station comprising:
at least one memory; and
at least one processor coupled with the at least one memory and configured to cause the base station to:
transmit an indication that a first transmission of on-demand essential system information (SI) is triggered in a cell, wherein the transmission of on-demand essential system comprises on-demand essential SI comprising first essential SI;
transmit the on-demand essential SI during a transmission window associated with the first transmission of on-demand essential SI;
transmit paging downlink control information (DCI) associated with the cell according to a first paging configuration; and
transmit paging DCI associated with the cell according to a second paging configuration and after a threshold duration elapses following the transmission window.

16. The base station of claim 15, wherein the indication that the first transmission of on-demand essential SI is received via a physical broadcast channel (PBCH).

17. The base station of claim 15, wherein the at least one processor is configured to cause the base station to transmit information indicating the threshold duration, the first paging configuration, and the second paging configuration.

18. The base station of claim 15, wherein the at least one processor is configured to cause the base station to transmit configuration information associated with the transmission window.

19. The base station of claim 15, wherein the at least one processor is configured to cause the base station to transmit an indication of a mode of operation associated with the cell.

20. The base station of claim 15, wherein the at least one processor is configured to cause the base station to transmit information indicating one or more of a second threshold duration, a first set of random access channel (RACH) configuration parameters, or a second set of RACH configuration parameters.
